(19) United States
(12) Patent Application Publication
(10) Pub. No.: US 2004/0117354 A1
(43) Pub. Date: Jun. 17, 2004

(54) Process for tagging and measuring quality

(76) Inventors: Steven Hector Azzaro, Schenectady, NY (US); Paul Edward Cuddihy, Ballston Lake, NY (US); Jeremiah Francis Donoghue, Ballston Lake, NY (US); Timothy Lee Johnson, Niskayuna, NY (US); Daniel Joseph Cleary, Schenectady, NY (US); Lijie Yu, Clifton Park, NY (US)

Correspondence Address: GENERAL ELECTRIC COMPANY (PCPI), C/O FLETCHER YODER, P. O. BOX 692289, HOUSTON, TX, 77269-2289, US

(21) Appl. No.: 10/318,681

(22) Filed: Dec. 16, 2002

(51) Int. Cl. G06F 17/30; G06F 7/00

(52) U.S. Cl. 707/3

(57) ABSTRACT

A system, method and computer program product is provided for tagging various portions of documents and measuring their usefulness for a particular purpose. The method takes a document that is to be tagged as input, and facilitates a user to tag various portions of the document, which the user considers as important. These tags are user-defined. Subsequently, the usefulness of the document for a particular purpose is determined by calculating quality of the document. The quality of a document is a combination of completeness and various other factors such as priority and severity as reported by a customer. Quality is used to sort results of a search query, which is made by the user, on the documents.

### BACKGROUND OF THE INVENTION

The present invention relates to the field of document tagging. More specifically, the present invention relates to a method and apparatus for tagging and measuring quality.

Knowledge plays an important part in the functioning of any business enterprise. In the present age, almost all of the business enterprises create knowledge as part of their day-to-day activities and various projects. To ensure that the knowledge is not lost and can be reused later, proper management of this knowledge is necessary. To this end, business organizations typically store their created knowledge in documents, and manage the knowledge using knowledge management tools and applications.

Typically, a business enterprise has a lot of information from its various processes. This information can be used to derive knowledge that is relevant to the enterprise. A problem faced by many business enterprises is how to extract useful and relevant knowledge from a large amount of information. This is further compounded by the fact that the amount of information keeps on continuously increasing with time, as all information related to any ongoing projects and processes of a business enterprise are appended to it.

An example of a business enterprise that deals with a large amount of information and needs to constantly derive useful information from the same is a call center. Call centers have product users, technicians, and other people calling in with their problems. To these problems, the call center personnel suggest various solutions. The problems reported by the users, the solutions suggested by the call centre personnel as well as some additional comments by the call center personnel are usually stored in documents known as “case notes”.

On most occasions, the people who contact call centers have problems that have been identified and solved by the call center personnel before. To improve their performance in terms of diagnosing the problem and suggesting solutions to it, call center personnel use the knowledge that resides in the case notes. There are many other ways in which a call center can take advantage of the knowledge that resides in the case notes. For example, by knowing the cause of a certain kind of problem, they can suggest preventive measures to the users so as to avoid the recurrence of that problem. Such usage of the knowledge that resides in the case notes saves time and monetary resources of call centers.

Call centers implement various methodologies and systems that help in managing their information as well as deriving knowledge from it. Most of the time, information is stored in an unstructured textual format, and thus does not lend well towards searching and reuse. Often, to extract useful knowledge from this stored information, users have to do a simple linear search, in which results are determined on the basis of frequency of occurrence of keywords in the documents that were searched, or use tools like search engines, in which the results are sorted based on a predefined quality measure.

Another problem faced by call centers is that many of the case notes are incomplete in terms of providing useful information. Case notes often contain a lot of unnecessary information, which comprises the comments put in by the call center personnel. So, if any one of the above-mentioned methods is used then the results would be based on the search conducted on these comments as well. This in turn, may lead to irrelevant search results.

To make the knowledge extraction process better, documents are usually “tagged” with markup tags. Tagging a document classifies the contents of the document, and makes searching the document easier.

The existing techniques fail to appreciate and efficiently address the above-mentioned problems. Hence, there exists a need for a solution that addresses the problem faced in determining the utility of a document. Furthermore, the solution should be able to determine the usefulness of the document for a particular purpose.

### BRIEF SUMMARY OF THE INVENTION

The present invention is a system and method for tagging various portions of documents and measuring their usefulness for a particular purpose. In accordance with one aspect, the present invention provides a system and method which takes as input a document that is to be tagged, and facilitates a user to tag various portions of the document, which the user considers as important. These tags are user-defined. Subsequently, the usefulness of the document for a particular purpose is determined by calculating quality of the document. The quality of a document is a combination of completeness and various other factors such as priority and severity as reported by a customer. Quality of a document is calculated using pre-defined heuristics. Quality is used to sort the results of any search query, which was made by the user, on the documents.

In accordance with another aspect, the present invention provides a system and method for sorting relevant search results for a search query by a user.

In accordance with a further aspect, the present invention provides a system for tagging various portions of documents and determining the quality of the documents. The tags are user-defined. The user tags the documents and depending on the tags the quality of the documents is determined.

In accordance with a further aspect, the present invention provides a computer readable medium for tagging and determining quality of the documents.

In accordance with a further aspect, the present invention provides a method for tagging and measuring the usefulness of tagged documents for a particular purpose. The user does the tagging of the documents by selecting the text and associating with a user-defined tag. The quality of the tagged documents is determined using a pre-defined heuristic.

### BRIEF DESCRIPTION OF THE DRAWINGS

The various embodiments of the present invention will hereinafter be described in conjunction with the appended drawings provided to illustrate and not to limit the invention, wherein like designations denote like elements, and in which:

FIG. 1 is a block diagram showing the general environment in which one embodiment of the present invention works;

FIG. 2 is a flow chart that illustrates the working of one embodiment of the present invention;

FIG. 3 is a flow chart illustrating the method of tagging in accordance with one embodiment of the present invention; and

FIG. 4 is a flow chart illustrating a heuristic used for determining quality in accordance with one embodiment of the present invention.

### DETAILED DESCRIPTION OF THE INVENTION

Hereinafter, aspects in accordance with various embodiments of the invention will be described. As used herein, any term in the singular may be interpreted to be in the plural, and alternatively, any term in the plural may be interpreted to be in the singular.

The present invention is a system and method for facilitating users to tag various portions of documents and measure their usefulness for a particular purpose. In accordance with one embodiment of the invention, a user can manually tag a document with user-defined tags. The quality of the tagged documents is determined to measure the usefulness of the documents for a particular purpose and to sort the search results of a user query on the documents. When the user performs a search using a query, the results are sorted on the basis of quality.

In accordance with one embodiment, the present invention is envisioned to be working in a call center environment, in which the present invention works on case notes.

Although one embodiment of the present invention is envisioned to be operating on case notes, it may be noted that this does not limit the scope of the present invention in any manner. The present invention may be adapted to operate on other documents, as is obvious to one skilled in the art.

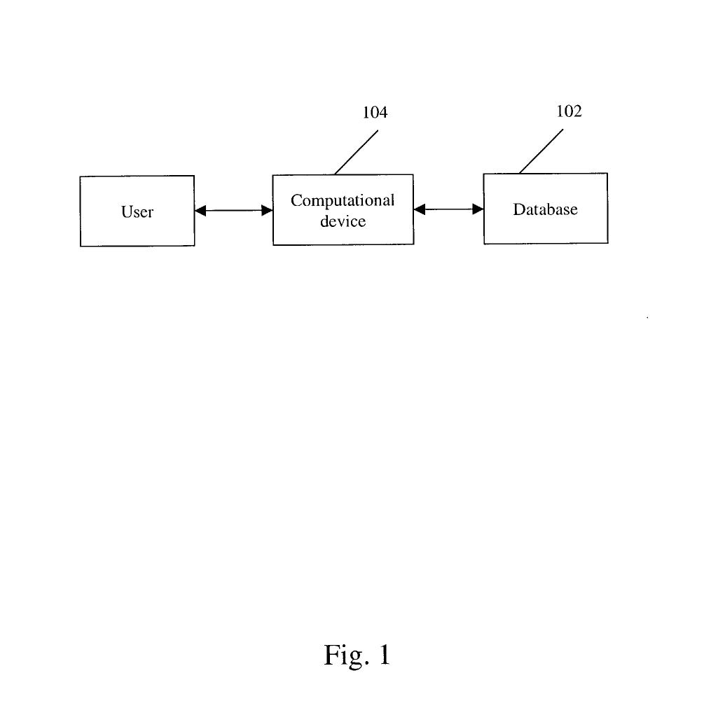

FIG. 1 is a block diagram showing the general environment in which one embodiment of the present invention works. The user accesses a database 102 through a computational device 104. Exemplary databases are Oracle Intermedia database and Microsoft SQL Server. It would be evident to one skilled in the art that various other databases can also be used. Typical examples of a computational device include a general purpose computer, a programmed microprocessor, a micro-controller, a peripheral integrated circuit element, and other devices or arrangements of devices, which are capable of carrying out the computation. Database 102 contains documents such as case notes. The user can tag the stored documents and also perform queries on the tagged documents. In accordance with one aspect of the present invention, the user can create new tags and assign a weight to each of them. This weight provides the basis for determining the quality of the document. This quality is then used in sorting the search result of a user query.

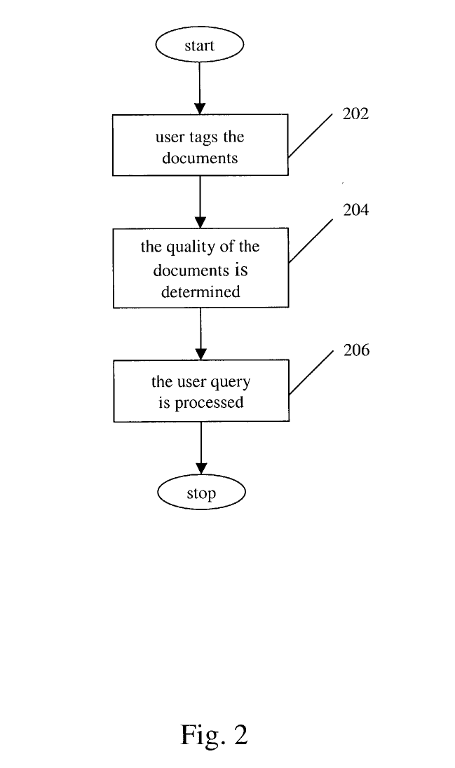

FIG. 2 is a flow chart that illustrates the working of one embodiment of the present invention.

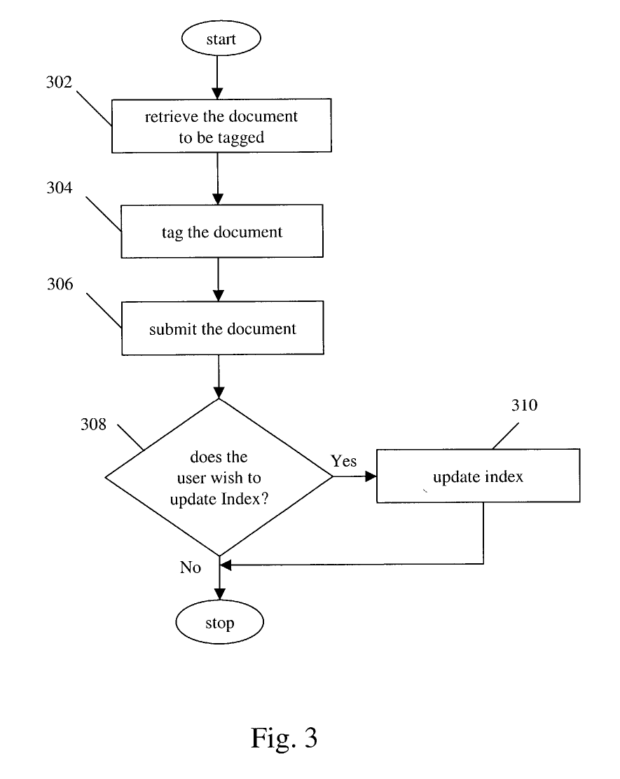

At step 202, the user tags a document retrieved from database 102. The step of tagging the document has been further explained in FIG. 3. The tags are user defined and correspond to various portions of the document. An exemplary document is shown below.

“Mary called from Jack's Paper Airplane mill today to say that the bridle drive with DC1000 drives is giving fault 35 again. The line seems to work for about 30 minutes the faults occur and tension drops. I called Fred since he's a genius about DC1000 drives but he didn't call back. I told Mary to cut the green wire because she loves to cut wires. This caused a power failure and so I told her to fix it. That kept her busy a good 2 hours.

Meanwhile Fred called to say the Tense-o-meter needs to be re-calibrated. I called Mary to tell her to run the Tenso-calibration tool. This fixed the problem.

Case closed.”

By way of an example, in the above mentioned case note, tags can be <PROBLEM> for “problems”, <ACTION> for “solutions”, <SYMPTOM> for “symptom”, <NOTE> for “notes” and <EQUIPMENT> for “equipments”.

At step 204, the quality of the document is determined. This quality is calculated on the basis of the number of times various tags occur in a document and their respective weights. These weights are user-defined and can be changed by the user depending on the relevance of tags.

At step 206, a user query is processed. In the user query, the user provides keywords that are indicative of the information that is being looked for. By way of an example, keywords can be “DC2000”, “DC5000”, “regulator” and “not working”. In accordance with one embodiment of the present invention, the keywords are searched in the tagged portion of the documents and result is generated. The result is arranged in decreasing order of the quality of the documents.

In accordance with one aspect of the present invention, the user query can also be a request for a report or a summary of the documents. A report is a document that lists several case fields including the calculated quality for each case. The case fields are chosen by the user. Exemplary case fields can be case ID, company name, severity, quality and title. This report is used to compute and evaluate the overall usefulness of the documents. A summary shows total number of documents in database 102, the number of documents already tagged, and their calculated quality.

FIG. 3 is a flow chart illustrating the method of tagging in accordance with one embodiment of the present invention. The tagging can be done using an XML editor. It is obvious to anyone skilled in the art that there exist many other tools that can also be used to achieve tagging. Exemplary tools are XMLSpy from Altova and XMLNotepad product from MicroSoft. It would be evident to one skilled in the art that various other tools can also be used.

At step 302, a document is retrieved from database 102 for tagging. In accordance with one embodiment of the invention, the selected document appears in a main text box, which is a Graphical User Interface (GUI) text window.

At step 304, the parts of the document to be tagged are selected by the user and tags are associated with each of them. The user marks up the document displayed in the main text box by selecting portions like sentence fragments, sentences and paragraphs, and then associating them with a tag. By way of an example, in the above-mentioned case, “bridle drive with DC1000 drives” is associated with an <EQUIPMENT> tag, “giving fault 35 again. The line seems to work for about 30 minutes the faults occur and tension drops” is associated with <SYMPTOM> tag, “Fred since he's a genius about DC1000 drives” is associated with <NOTE> tag, “Tense-o-meter needs to be re-calibrated” is associated with <PROBLEM> tag and “run the Tenso-calibration tool” is associated with <ACTION> tag.

To tag a portion of the document, the user has to select the relevant portion such as “bridle drive with DC1000 drives” and associate it with the <EQUIPMENT> tag. In accordance with one embodiment of the invention, this step of associating a tag with a portion of the document is done using a GUI. The color of all the tagged portions changes to different colors, depending on the respective tags with which they are associated. If the user selects a wrong portion of the document by mistake, then the user can double click on the selected area to unselect.

At step 306, the user submits the document to database 102.

At step 308, the user is asked whether an index should be updated. The index provides a reference number to the tagged documents in database 102. The documents can be partially or completely indexed. By way of an example, if database 102 is Oracle Intermedia database, then Oracle Intermedia index is used. The documents can be indexed completely, or some of the documents can remain outside the indexed database.

At step 310, the index is updated if the user wants to update index. In this step all the documents in database 102 are re-indexed. In accordance with one embodiment of the invention, only the documents whose indices have been updated are included in the search for a user query.

Along with the tagging of the documents by the user, quality is calculated for the document. Quality is a measure of information completeness and is a combination of completeness and factors like priority and severity and entered in the document as general information. The general information is displayed along with the document to the user while the user tags or views a document in the main text box. The information completeness is a function of the number of tags of each type and their weights.

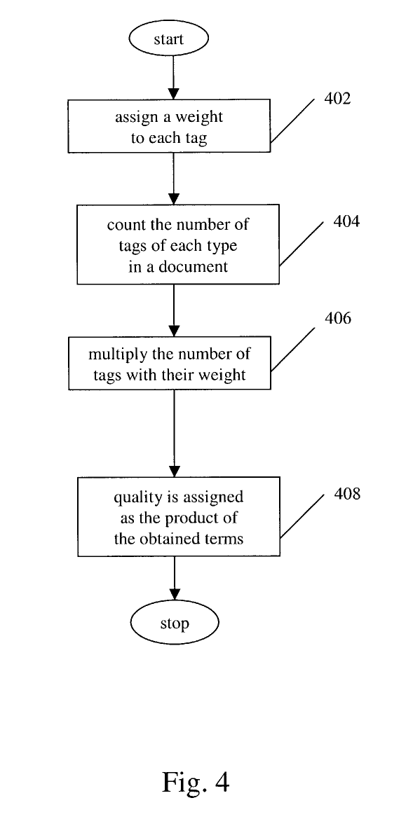

FIG. 4 is a flow chart illustrating a heuristic for determining quality in accordance with one embodiment of the present invention.

At step 402, a weight is assigned to each tag. This weight is predefined by the user. A user can define weight for a tag as per the relevance of that tag. For example, in the case stated above, <PROBLEM>, <SOLUTION> and <EQUIPMENT> tags are given a weight of 0.9 each, and <SYMPTOM> and <NOTE> tags are given a weight of 0.5 each.

At step 404, the number of tags of each type is counted in a document. For example, in the case stated above, there is one tag of each of the types <PROBLEM>, <SOLUTION>, <EQUIPMENT>, <SYMPTOM> and <NOTE>.

At step 406, the number of tags of each type is multiplied with their respective weight. For example, in the case stated above, the value would come out to be 0.9 for <PROBLEM>, <SOLUTION> and <EQUIPMENT> tags and 0.5 for <SYMPTOM> and <NOTE> tags.

At step 408, the values obtained at step 406 are multiplied with each other to generate the quality of the document. For example, in the case stated above, the value comes out to be 0.18225.

After the quality is determined for all the tagged documents and the indices updated, the user can enter a search query. The search query can be searched using a search tool. The search tools used would be dependent on the database used for storing the tagged documents. By way of an example, for Oracle InterMedia database, Oracle's InterMedia context enabled search engine is used and for Microsoft SQL server similar Microsoft tools are to be used. Results of the search query are then sorted on the basis of the quality. In accordance with one embodiment of the present invention, the user can define a threshold value, which is used to sort the results. The results, which have quality less than a pre-defined threshold value, are then ignored. The user query is entered in a GUI text window. For instance, the user's first query might be: “Select * from DATABASE”. This will bring up all cases in the database. A query such as: “Select * from DATABASE where quality=0” will bring up all untagged cases. The highest quality is 1.0. So, a query like “Select * from DATABASE where quality=1” will bring up all cases with quality=1.

The system, as described in the present invention or any of its components may be embodied in the form of a processing machine. Typical examples of a processing machine include a general purpose computer, a programmed microprocessor, a micro-controller, a peripheral integrated circuit element, and other devices or arrangements of devices, which are capable of implementing the steps that constitute the method of the present invention.

The processing machine executes a set of instructions that are stored in one or more storage elements, in order to process input data. The storage elements may also hold data or other information as desired. The storage element may be in the form of a database or a physical memory element present in the processing machine.

The set of instructions may include various instructions that instruct the processing machine to perform specific tasks such as the steps that constitute the method of the present invention. The set of instructions may be in the form of a program or software. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

A person skilled in the art can appreciate that it is not necessary that the various processing machines and/or storage elements be physically located in the same geographical location. The processing machines and/or storage elements may be located in geographically distinct locations and connected to each other to enable communication. Various communication technologies may be used to enable communication between the processing machines and/or storage elements. Such technologies include connection of the processing machines and/or storage elements, in the form of a network. The network can be an intranet, an extranet, the Internet or any client server models that enable communication. Such communication technologies may use various protocols such as TCP/IP, UDP, ATM or OSI.

In the system and method of the present invention, a variety of “user interfaces” may be utilized to allow a user to interface with the processing machine or machines that are used to implement the present invention. The user interface is used by the processing machine to interact with a user in order to convey or receive information. The user interface could be any hardware, software, or a combination of hardware and software used by the processing machine that allows a user to interact with the processing machine. The user interface may be in the form of a dialogue screen and may include various associated devices to enable communication between a user and a processing machine. It is contemplated that the user interface might interact with another processing machine rather than a human user. Further, it is also contemplated that the user interface may interact partially with other processing machines while also interacting partially with the human user.

While the various embodiments of the present invention have been illustrated and described, it will be clear that the present invention is not limited to these embodiments only. Numerous modifications, changes, variations, substitutions and equivalents will be apparent to those skilled in the art without departing from the spirit and scope of the invention as described in the claims.

What is claimed is:

1. A method for tagging and measuring quality of a plurality of documents, the method comprising the steps of:
a. tagging portions of the documents by a user; and
b. determining quality of the tagged documents.

2. The method as recited in claim 1 wherein the method further comprises the step of processing a user query on the tagged documents.

3. The method as recited in claim 1 wherein the step of tagging comprises:
a. selecting a portion of the document to be tagged, the selection being done by the user; and
b. associating the selected portion with one or more pre-defined tags, the association being done by the user.

4. The method as recited in claim 1 wherein the step of determining quality comprises calculating quality of the document based on a pre-defined heuristic.

5. The method as recited in claim 2 wherein the processing of user query comprises:
a. searching the user query on tagged portions of the documents; and
b. arranging the search result on basis of the determined quality.

6. The method as recited in claim 5 wherein the step of arranging the search result comprises:
a. selecting the documents that have quality greater than a pre-defined threshold; and
b. sorting the selected documents in descending order of the quality.

7. A system suitable for tagging and measuring quality of a plurality of documents, the system comprising:
a. a tagging module for tagging text of the documents by a user;
b. a quality evaluator module for determining quality of the tagged documents; and
c. a query processing module for performing a user query on the tagged documents.

8. A computer program product for use with a computer, the computer program product comprising a computer usable medium having a computer readable program code embodied therein for tagging and measuring quality of a plurality of documents, the computer program code performing the steps of:
a. tagging text of the documents by a user; and
b. determining quality of the tagged documents.

9. The computer program product of claim 8 wherein the computer program code further performs the steps of:
a. searching a user query on tags of the tagged documents; and
b. arranging search result on basis of determined quality.

10. A method for tagging and measuring quality of a plurality of documents, the method comprising the steps of:
a. tagging portions of the documents by a user wherein the step of tagging comprises:
i. selecting a portion of the document to be tagged, the selection being done by the user; and
ii. associating the selected portion with one or more pre-defined tags, the association being done by the user;
b. determining quality of the tagged documents wherein the step of determining quality comprises calculating quality of the document based on pre-defined heuristics, and
c. processing a user query on the tagged documents.

11. A system suitable for tagging and measuring quality of a plurality of documents, the system comprising:
a. a tagging module for tagging text of the documents by a user;
b. a quality evaluator module for determining quality of the tagged documents; and
c. a query processing module for performing a user query on the tagged documents wherein the query processing module further comprises:
i. a searching module for searching a user query on tags of the tagged documents; and
ii. a sorting module for arranging search result on basis of quality.

12. A computer program product for use with a computer, the computer program product comprising a computer usable medium having a computer readable program code embodied therein for tagging and measuring quality of a plurality of documents, the computer program code performing the steps of:
a. tagging text of the documents by a user;
b. determining quality of the tagged documents;
c. performing a user query on tags of the tagged documents; and
d. arranging search result on basis of determined quality.
